(19) United States
(12) Patent Application Publication
(10) Pub. No.: US 2014/0326914 A1
(43) Pub. Date: Nov. 6, 2014

(54) VALVE

(71) Applicants: Richard Roy Wood, Johannesburg (ZA); Murray Bredin, Johannesburg (ZA)

(72) Inventors: Richard Roy Wood, Johannesburg (ZA); Murray Bredin, Johannesburg (ZA)

(73) Assignee: ERLS MINING (PTY) LTD, Johannesburg (ZA)

(21) Appl. No.: 13/982,988

(22) PCT Filed: Jan. 31, 2012
(86) PCT No.: PCT/ZA12/00005

§ 371 Date: Jun. 13, 2014

(30) Foreign Application Priority Data
Jan. 31, 2011 (ZA) 2010/06997

(51) Int. Cl. F16K 15/04

(52) U.S. Cl. CPC F16K 15/04
USPC 251/315.01

(57) ABSTRACT

A valve with a housing (12) in which is formed a chamber (14), an inlet (16) to the chamber, an outlet (18) from the chamber which is at a right angle relative to the inlet, a metallic valve seat (90) at the inlet, a resilient valve seal (100) mounted to the valve seat at the inlet and a spherical valve member (40) inside the chamber.

### BACKGROUND OF THE INVENTION

This invention relates to a one-way valve which is suitable for use in a harsh environment and which is capable of functioning at a high pressure and at a high frequency of operation.

The applicant is aware of a one-way valve which is based on the use of a spherical valve member. In one application two of these valves are used with a diaphragm pump member. One valve is upstream of the diaphragm and the other is downstream of the diaphragm. Effectively the valves run in series with each other and the diaphragm is between the valves.

The applicant's international patent application number PCT/ZA2009/000071 entitled Pumping System (referred to hereinafter as the “earlier specification”, the content of which is hereby incorporated into this specification) describes a bladder-based arrangement capable of operating under high pressures which is suited, inter alia, for the pumping of abrasive slurries and the like. The pumping operation is controlled, at least, by the use of a manifold which acts to divert fluid flow into, and out, of different bladder-containing vessels. This type of pumping system has underlined the need for a one-way valve which has a low wear rate in the presence of abrasive slurries and the like. Additionally, the valve should have sacrificial wear components that can be replaced at a low cost and with minimal downtime, and an effective sealing action must be displayed by sealing faces of the valve even if the faces have been abraded to some extent.

A seal and a valve member of a pinch-type valve, and of a quarter-turn valve such as a ball, butterfly and taper plug valve, are prone to erosion damage when actuated against a high differential pressure particularly in an abrasive medium such as a slurry. This is primarily due to the fact that the seal and valve member form an orifice which reduces in size to zero, as the valve closes and which increases in size from zero, as the valve opens. The speed of the slurry flow through the orifice is inversely proportional to the size of the orifice and, with the slurry at a high pressure, particles in the slurry, due to the high resulting speeds of slurry flow, acquire sufficient energy to abrade even the hardest materials.

The action of a ball check valve provides substantially instantaneous opening and closing of a constant aperture so that the velocity of fluid flow between the seal and the valve member is kept at a low level. In this context it is noted that the earlier specification describes a pumping system which permits actuation of a ball check valve only when a pressure differential in the pumping vessel is reduced effectively to zero. This feature, inherently, extends the operating lifetime of the seal and of the valve member.

In a valve of conventional construction coupling flanges which are provided on the valve increase in size and cost as the designed operating pressure of the valve increases. By way of contrast the valve body parts which are attached to the flanges are relatively light and are the parts which are subject to abrasion. An unfortunate consequence of this type of construction is that when the valve body parts are no longer specification-compliant, the entire valve structure, which is normally cast or fabricated, is discarded. Typically about 80% of the mass of the valve structure consists of the flanges which are still serviceable.

An object of the present invention is to address, at least partly, the aforementioned situation.

Solid particles in a slurry may foul a conventional valve seat and prevent the formation of a leak-tight seal. The solid particles can damage the sealing faces directly by physical contact therewith. The sealing faces can also be indirectly damaged by the particles if the particles prevent the valve from sealing. This could allow slurry backflow which erodes the sealing faces. Apart therefrom the solid particles may foul a sealing mechanism and prevent the mechanism from moving between its open and closed positions.

An object of the present invention is to provide a one-way valve which to a substantial extent addresses the aforementioned factors. A further object of the invention is to provide a one-way valve which lends itself readily for incorporation into a pumping system of the kind referred to in the earlier specification in an effective, compact and relatively inexpensive manner.

### SUMMARY OF INVENTION

The invention provides a valve which includes a housing in which is formed a chamber, an inlet, to the chamber, through which fluid flows in a first direction, an outlet, from the chamber, through which fluid flows in a second direction which is transverse to the first direction, an annular seal adjacent the inlet, an annular valve seat adjacent the seal, a flange structure which is secured to the housing and which is engaged at least with the seal and with the valve seat, and a spherical valve member which is movable inside the chamber and which is sealingly engageable at least with the seal.

The flange structure may include a retention assembly with a locating formation with which the annular valve seat is engageable.

The annular valve seat may comprise a collar which, over at least a part of its axial length, is shaped to assist in curtailing turbulence which could be induced in the fluid flow as the fluid flows into the chamber. The collar (i.e. the annular valve seat) is considered to be a wear item and, preferably, is engaged with the retention assembly by means of a press fit.

Opposing surfaces of the annular valve seat and of the retention assembly may define an undercut formation with which a formation, on the seal, which is of complementary shape to the undercut formation, is engageable.

The flange structure may include a weld neck which is secured to the housing on an outer side of the housing surrounding the inlet and a ring which is enagageable with a plurality of fasteners and which is coupled to the weld neck through the medium of a snap-ring or a similar device.

The seal is preferably made from a slightly resilient material such as a suitable polymer e.g. a polyurethane material.

The retention assembly may include a seat retaining ring and a seal retaining ring which are secured to each other and which define a recessed annular formation with which a projection on the seal, of complementary shape, is engageable.

The seal may include an outer surface which abuts an inner surface of the housing and an inner surface which defines a short passage of generally reducing cross-sectional size proceeding from an interior of the housing towards the inlet. The inner surface may have a generally conical shape and may include at least one and preferably at least two sealing formations.

A part of the inner surface of the seal and an opposing surface of the spherical valve member, when the spherical valve member is engaged with the seal, may define an annular volume exposed to an interior of the chamber which permits fluid inside the chamber to pressurise the seal and so enhance its sealing effect.

An inner surface of the housing, defining the chamber, may be lined with rubber or a similar wear-resistant material.

The chamber may include a storage volume into which the valve member is movable so that fluid flow from the inlet to the outlet is not impeded by the valve member.

The size of the storage volume may thus be at least equal to, but preferably is greater than, the size of the volume of the spherical valve member.

The second direction is preferably at a right angle to the first direction. The first direction, in use, is vertical and the second direction, in use, is thus horizontal.

The valve member may be constructed from a material or materials to ensure that it has a specific gravity which is greater than the specific gravity of a medium, typically a slurry, which passes through the valve. In the absence of fluid flow through the housing this feature allows the valve member to settle under gravity action onto the seal.

To prevent the valve member from being moved through the outlet by fluid flow in the second direction, the cross-sectional area of the outlet is restricted relative to the cross-sectional dimensions of the valve member.

In a form of the invention which is particularly suited for use in a pumping system of the kind described in the earlier specification (although this form of the invention is not confined to this type of application), first and second valves are used with each valve being of the aforementioned kind. The first valve is positioned below the second valve and an opening formed in the housing of the first valve is used to define an inlet to the second valve. Slurry can flow into the chamber of the first valve through its inlet. The valve member in the first valve then seats against the opening and ensures that fluid flows through the outlet of the first valve into a bladder-containing vessel of the pumping system. Fluid expelled from the vessel enters the chamber of the first valve through the outlet thereof. The second valve is then opened with fluid flowing from an interior of the first valve through the opening into the chamber of the second valve, before exiting via the outlet of the second valve.

### BRIEF DESCRIPTION OF THE DRAWINGS

The invention is further described by way of example with reference to the accompanying drawings in which:

FIG. 1 illustrates in cross-section a valve according to the invention in an open configuration;

FIG. 2 shows the valve of FIG. 1 in an initial closed configuration;

FIG. 3 shows the valve of FIG. 2 under high pressure and with a deformed seal;

FIG. 4 is a view on an enlarged scale and in cross-section of part of the valve of FIG. 2;

FIG. 5 shows, in perspective, and partly in cross-section, components of the seal and seat assembly in exploded and assembled configurations; and

FIG. 6 illustrates how a compound valve, primarily consisting of two valves each of the kind shown in FIG. 1, is constructed and used.

### DESCRIPTION OF PREFERRED EMBODIMENT

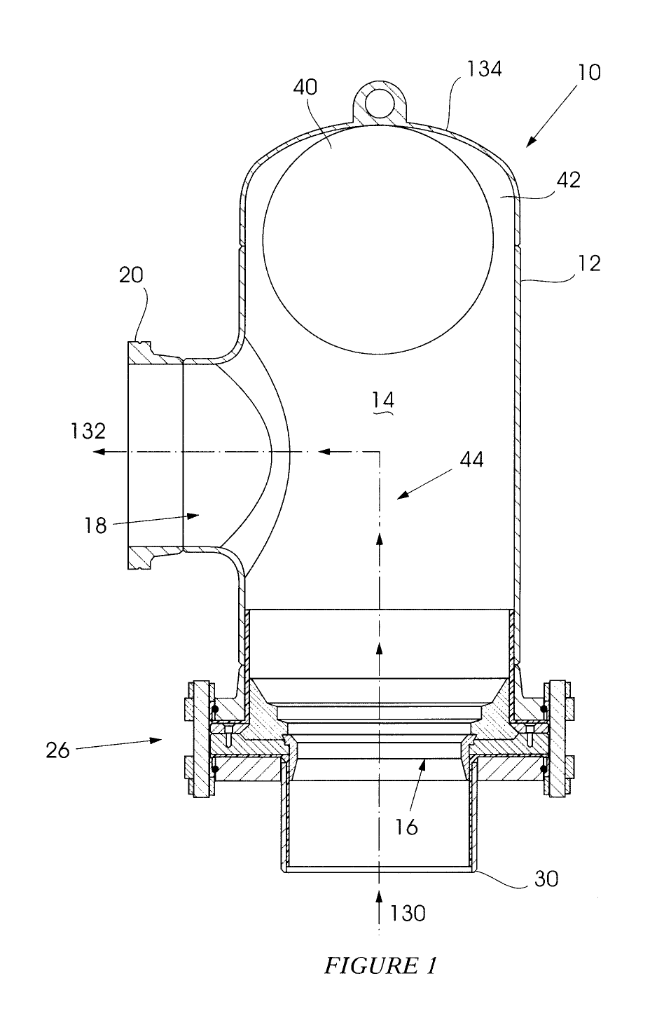

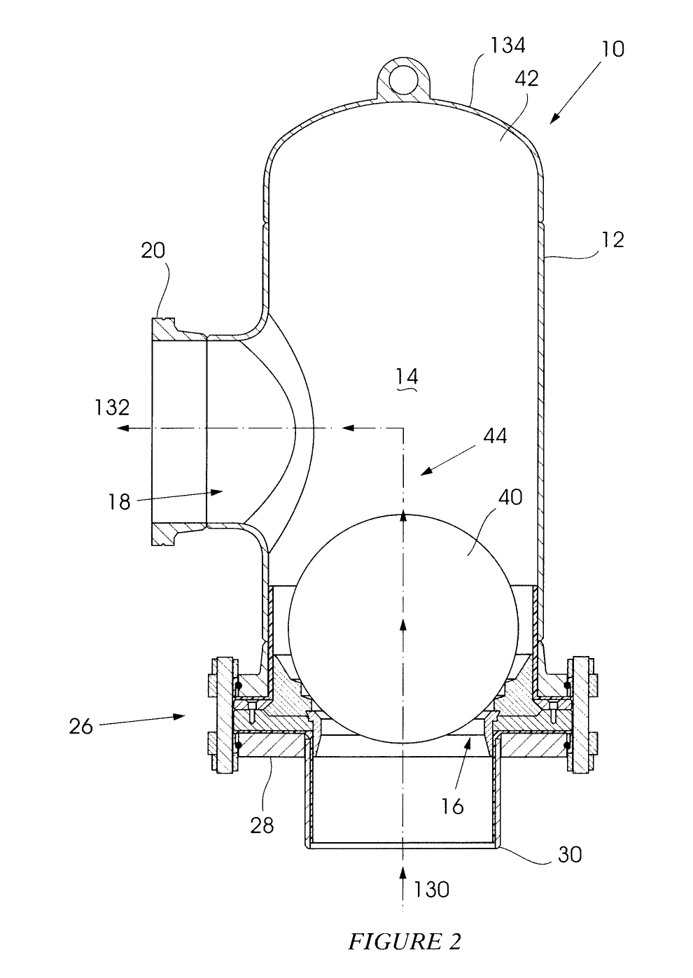

FIGS. 1 and 2 of the accompanying drawings are views in cross-section and from one side of a valve 10 according to a first form of the invention in an open configuration, and in a closed configuration, respectively.

The valve includes a housing 12 in which is formed a chamber 14 which has an inlet 16 and an outlet 18. A flange 20 at the outlet is used to couple the valve to a downstream pipe (not shown). The flange 20 may be of a conventional construction but preferably has a construction which is similar to that described herein with reference to a flange at the inlet.

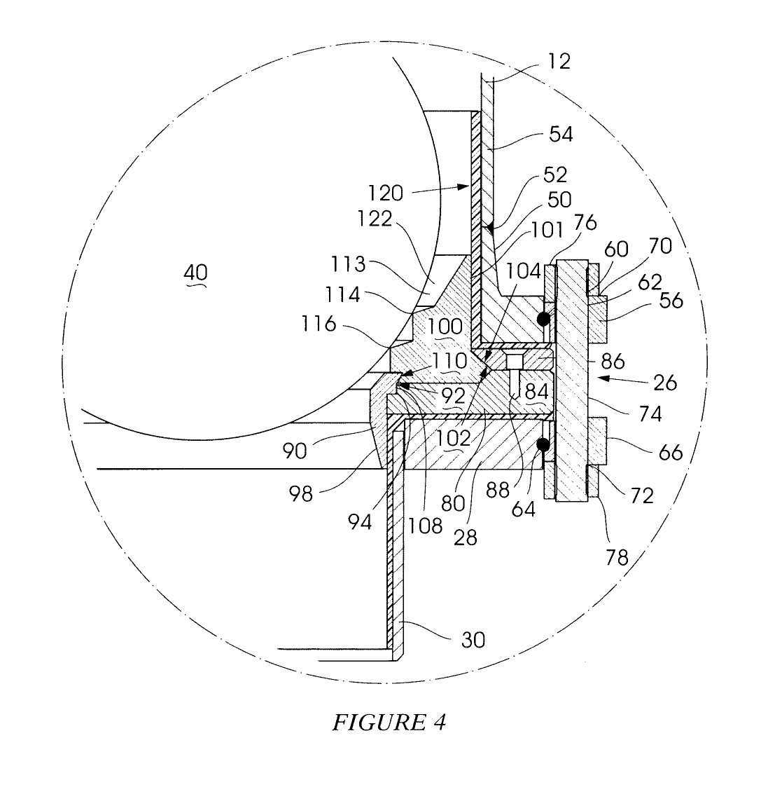

A flange structure 26, described hereinafter in greater detail with reference particularly to FIG. 4, is used to couple the inlet 16 to an externally grooved flange 28 which is welded to a pipe 30. The flange structure 26 is attached to the housing 12.

The chamber cross-sectional area is greater than the cross-sectional area of the inlet to allow for a slight reduction in the velocity of fluid flow through the chamber. This in turn reduces wear on an inner surface of the housing which could be attributed to turbulence. The cross-sectional area of the inlet is substantially the same as the cross-sectional area of the outlet.

A spherical valve member 40 is located in the chamber 14. The chamber has an upper storage volume 42 which accommodates the valve member when the valve is in an open configuration (FIG. 1). The size of the volume 42 is thus greater than the size of the volume of the valve member. When the valve is open the valve member is displaced from a fluid flow path 44 between the inlet 16 and outlet 18 and thus does not impede the flow of fluid.

The valve member 40 has a specific gravity which is dictated at least by the specific gravity of a fluid, e.g. a slurry, with which the valve 10 is to be used. An objective in this respect is to ensure that the valve member can settle under gravity action to a sealing position on the flange structure 26 (FIG. 2) when fluid flow along the path 44 is stopped by downstream means (not shown). By way of example only the valve member is formed from a spherical steel element which is externally coated with polyurethane or a similar wear-resisting and resilient sealing material. An interior of the spherical steel member contains a filler with a calculated mass which ensures that the valve member has a predetermined specific gravity.

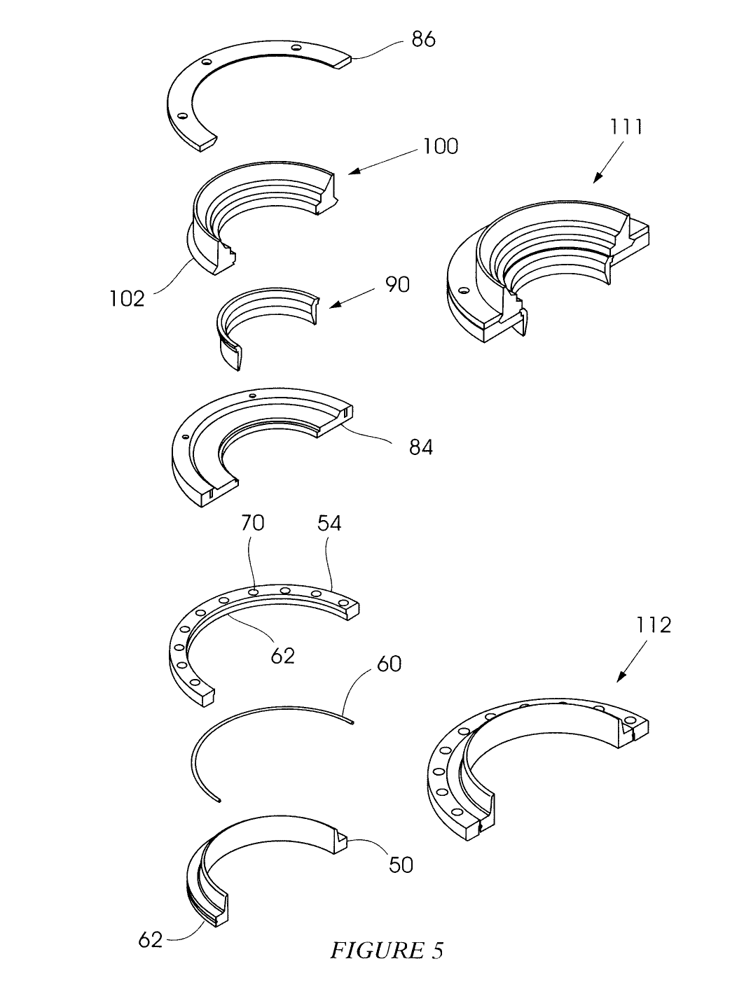

The flange structure 26, shown in detail in FIG. 4, is specifically designed to be easy to fabricate and to promote an effective sealing action particularly under substantial fluid pressures. Moreover the design is one in which the use of complex and expensive components is kept to a minimum and is such that service and maintenance requirements can be met with minimum down-time. Components of the flange structure, and components of a seal and a seat, are shown in FIG. 5 in cross-section and perspective, in exploded and in assembled configurations.

The flange structure 26 includes an externally grooved weld neck 50 which is welded at a location 52 to a lower end 54 of a tubular portion of the housing 12 upstream of the inlet. A cast ring 56, co-axially positioned relative to the weld neck, is directly engaged with the weld neck by means of a snap ring 60 which is located in locking formations 62 formed between opposing surfaces of the cast ring and the weld neck. The flange 28 on the pipe 30 is similarly connected by means of a snap ring 64 to a surrounding cast ring 66. The rings 56 and 66 have opposed holes 70 and 72 respectively at locations which are spaced around the circumference of the rings, and studs 74 pass through the registering holes. Nuts 76 and 78, engaged with respective opposing protruding ends of the studs, are used to secure the flanges together.

The flange structure 26 also includes a retention assembly 80 which is located between opposing surfaces of the externally grooved weld neck 50 and the externally grooved flange 28. The retention assembly includes a seat retainer ring 84 and an overlying seal retaining ring 86. These rings are coupled to each other by means of a plurality of countersunk fasteners 88 which are circumferentially spaced from each other.

The rings 84 and 86 are made from a relatively low grade steel. By way of contrast an annular valve seat 90 is made from a high grade steel, typically hardened stainless steel. This seat is engageable with a press fit with the ring 84 and includes a formation 92 which rests on a shoulder 94 formed in a peripheral inner surface of the ring. The valve seat encloses a short passage of increasing diameter, i.e. of increasing area, proceeding from an interior of the chamber towards the inlet. Of importance is a tapered leading end 98 which extends into the pipe 30. This arrangement helps to reduce turbulence of flow as fluid flows into the chamber.

An annular valve seal 100 is engaged with the retention assembly and with the valve seat. An outer surface 101 of the seal abuts an inner surface of the housing. The seal is made from a suitable polymer e.g. polyurethane of an appropriate grade. The seal has an outer annular projection 102 which extends into a locating V-shaped annular recess 104 defined between opposing surfaces of the rings 84 and 86. Additionally, the seat 90 and the ring 84 define a small wedge-shaped undercut formation 108 into which a projection 110, on the seal, which is of complementary shape to the undercut formation, is insertable. These features help to ensure that the annular seal is kept firmly in position.

FIG. 5, on the right side, illustrates how the components 84, 86, 90 and 100 are assembled to make up an assembled seal and seat arrangement 111 and how the components 50, 54 and 60 are assembled into a flange assembly 112. Referring again to FIG. 4 the arrangement 111 is sandwiched between raised sealing faces of the flange 28 and the weld neck 50 and is concentrically aligned with the housing 12 at least by means of the studs 74. The raised sealing faces of the flange and of the weld neck are lined with rubber and consequently no gasket or additional sealing mechanism is required to effect a leak-tight construction.

On what is referred to as an inner surface 113 the seal has a generally conical shape with two distinct and spaced apart sealing formations 114 and 116 respectively. Moving away from the seat 90 the surface 113 tapers outwardly towards a rubber-lined inner surface 120 of the housing. An annular gap 122 is formed between opposing surfaces of the seal and the valve member 40, when it rests on the seal, and this gap is exposed to pressure inside the chamber. The effect of the pressure helps to force the seal against adjacent surfaces and this enhances the sealing effect.

An outer surface of the valve member 40, and the valve seal 100, are formed from an appropriate semi-rigid material. This is important because any small hard particles such as rocks or pebbles which are entrained in a liquid, passing through the valve and which become positioned between opposing surfaces of the valve member and the valve seal, can cause deformation of the material on the surface of the valve member, or of the valve seal, but in such a way that a sound seal will still be achieved. However, when the valve member is displaced from the valve seal these particles are normally flushed away and due to the inherent resilience of the material on the surface of the valve member, and of the material from which the valve seal is made, these components then automatically reassume their original shapes.

In use the valve member is positioned so that the pipe 30 is vertically orientated i.e. aligned with a vertical direction 130 and so that the outlet is horizontally positioned i.e. aligned in a direction 132. As stated the valve member has a specific gravity which is greater than the specific gravity of the fluid with which the valve is to be used. Thus, if there is no fluid flow through the chamber the valve member moves downwardly automatically under gravity action into engagement with the valve seal.

Fluid flows from the pipe 30 through the inlet 16 in the direction 130, into the chamber 14. The valve member 40 is thereby displaced into the storage chamber 42 and does not impede fluid flow through the chamber. The fluid exits the chamber through the outlet 18 in the direction 132.

As the first direction 130 is at a right angle to the direction 132 it is possible, in the fabrication of the valve, to make use of standard butt-weld fittings. For example the housing 12 comprises a reducing T-piece with a 2:1 semi-ellipsoidal end cap 134 secured to one outlet of the T. A junction pipe of standard dimensions is readily coupled to the outlet 18.

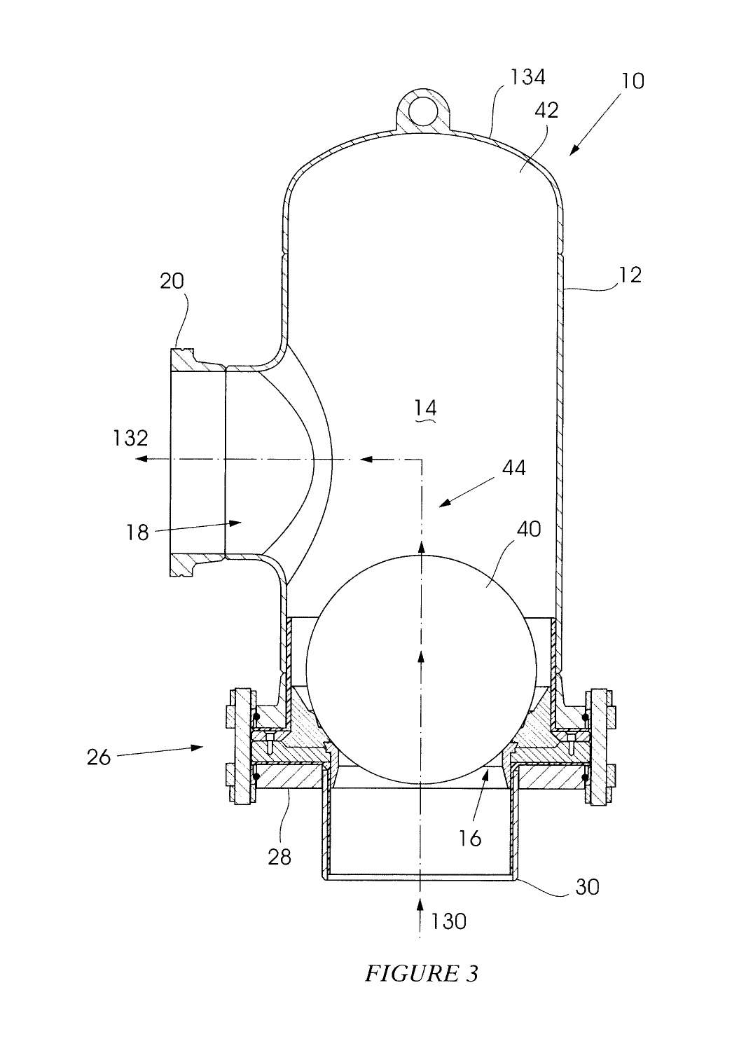

When fluid attempts to flow from the chamber 14 through the inlet 16, i.e. in the reverse direction, the valve member automatically engages with the annular valve seal 100. The sealing surfaces 114 and 116 are presented to the valve member and thus a serial sealing effect is achieved which is shown, at an initial stage, in FIG. 2. If a substantial high pressure pertains inside the chamber then the valve member is moved gradually towards the valve seat. This movement can only take place if the valve seal is deformed and, to some extent, if an outer surface of the valve member is also deformed. The valve seat, however, arrests further movement of the valve member. At this stage the sealing formations 114 and 116 are tightly engaged with opposing surfaces of the valve member. The valve seal and the valve member are shown, fully deformed, in FIG. 3. An additional sealing effect is created by high fluid pressure inside the chamber which acts on a surface of the seal exposed via the gap 122. The resultant force helps to deform the seal into tight engagement with adjacent abutting surfaces.

If fluid flow through the inlet into the chamber is to be prevented then an actuator, not shown, which extends through the end cap 134, is operated to displace the valve member towards the valve seal and the valve seat and then to keep the valve member in position firmly engaged with the valve seal and the valve seat.

The valve of the invention finds particular application in a pumping system of the kind described in the earlier specification. That type of pumping system is capable of handling an abrasive slurry at a high pressure. During operation the system cycles repeatedly through zero pressure points. At these points a valve of the kind described herein can readily be displaced from an open to a closed position, or vice versa, and thereby exhibit its valve function. The changing of the valve from an open to a closed position is done rapidly while the slurry is at a low pressure and consequently wear on the valve member or on the valve seal or seat, due to the abrasive fluid, is materially reduced. Nonetheless if wear does take place it is a relatively easy matter to recondition or service the valve. For example, once the studs 74 are loosened the retention assembly 80 can be detached. The seal 100 can be replaced and so can the seat 90. These items are generally regarded as wear items and their replacement is effected without meaningfully affecting the integrity of the housing.

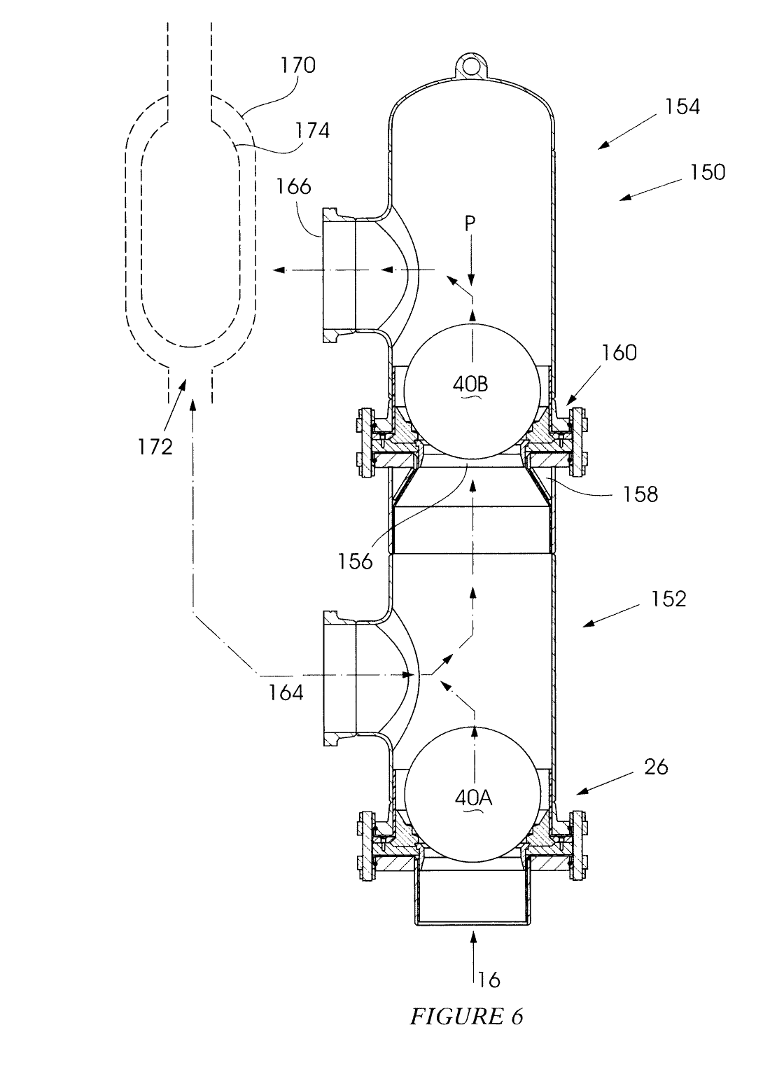

FIG. 6 shows a compound valve 150, according to the invention, which is particularly suited for use in the pumping system referred to. The valve 150 includes a first valve 152 which is generally of the kind shown in FIGS. 1 and 2, and an overlying second valve 154 which has a substantially similar construction. However the domed end cap 134 of the lower first valve 152 is removed and, in its place, an opening 156 is constructed. This opening has a surrounding annular conical member 158 which is fixed to the housing of the lower valve, leading directly to an inlet of the upper valve 154.

The remainder of the valve 152 is similar to what has been described.

A flange structure 160 and a retention assembly at an inlet to the upper valve 154 are substantially the same as the flange structure 26 and the retention assembly 80 (as described).

The inlets 16 and 156 to the first and second valves respectively are vertically aligned. Outlets 164 and 166 respectively from the valves are horizontally disposed. These outlets could face in the same direction or in any other chosen direction.

The valve 152 has a valve member 40A and the valve 154 has a valve member 40B.

The outlet 164 is connected to a vessel 170 (shown schematically only) in a pumping system of the kind described in the earlier specification. This vessel has an opening 172 which functions as an inlet and as an outlet and a bladder 174 is located inside the vessel. The outlet 166 is connected to an output line (not shown) of the pumping system.

When slurry flows through the inlet of the first valve the corresponding valve member 40A moves upwardly and stops against an underside of the valve member 40B which is held closed by back pressure P. The slurry is thereby diverted through the outlet 164 into the vessel. When the bladder 174 in the vessel is expanded (in operation of the pumping system) the slurry is forced from the vessel and into the interior of the valve 152 through the outlet 164. The valve member 40A of the first valve engages with a sealing action on the seal adjacent the inlet of the first valve member. The flow of slurry is thus diverted into the upper valve 154 through the conical member 158. The valve member 40B in the upper valve is moved away from the flange structure 160 to allow unimpeded slurry flow to take place through the interior of the second valve to the outlet 166.

The aforementioned arrangement is particularly beneficial in that it provides a compact and cost effective structure which permits fluid flow into the vessel 170 and out of the vessel while allowing the compound valve to switch between different modes of operation while the slurry pressure is relatively low. It is to be noted that in contrast with the diaphragm-type pump referred to in the preamble hereof the two valves which are embodied in the compound valve are disposed to one side of the bladder and are not in series with the vessels or pump chambers.

1. A valve which includes a housing in which is formed a chamber, an inlet, to the chamber, through which fluid flows in a first direction, an outlet, from the chamber, through which fluid flows in a second direction which is transverse to the first direction, an annular seal adjacent the inlet, an annular valve seat adjacent the seal, a flange structure which is secured to the housing and which is engaged at least with the seal and with the valve seat, and a spherical valve member which is movable inside the chamber and which is sealingly engageable at least with the seal

2. A valve according to claim 1 wherein the flange structure includes a retention assembly with a locating formation with which the annular valve seat is engageable.

3. A valve according to claim 2 wherein the retention assembly includes a seat retaining ring and a seal retaining ring which are secured to each other and which define a recessed annular formation with which a projection on the seal, of complementary shape, is engageable.

4. A valve according to claim 2 wherein opposing surfaces of the annular valve seat and the retention assembly define an undercut formation with which a formation, on the seal, which is of complementary shape to the undercut formation, is engageable.

5. A valve according to claim 1 wherein the flange structure includes a weld neck which is secured to the housing on an outer side of the housing surrounding the inlet and a ring which is enagageable with a plurality of fasteners and which is coupled to the weld neck through the medium of a snap-ring.

6. A valve according to claim 1 wherein the seal includes an outer surface which abuts an inner surface of the housing and an inner surface which defines a passage of generally reducing cross-sectional size proceeding from an interior of the housing towards the inlet.

7. A valve according to claim 6 wherein the inner surface has at least two spaced sealing formations.

8. A valve according to claim 1 wherein a part of an inner surface of the seal and an opposing surface of the spherical valve member, when the spherical valve member is engaged with the seal, define an annular volume exposed to an interior of the chamber which permits fluid inside the chamber to pressurise the seal and so enhance its sealing effect.

9. A valve according to claim 1 wherein the chamber includes a storage volume which is greater than the volume of the spherical valve member and into which the valve member is movable so that fluid flow from the inlet to the outlet is not impeded by the valve member.

10. A compound valve which includes a first valve and a second valve, each valve being according to claim 1 wherein the first valve has an outlet, opposing its inlet, connected to the inlet of the second valve.
